(19) United States
(12) Patent Application Publication
(10) Pub. No.: US 2026/0266133 A1
(43) Pub. Date: Sep. 10, 2026

(54) ROLLER BLIND WITH TENSIONING DEVICE

(71) Applicant: SHANGHAI QING FAN INTELLECTUAL SUNSHADE TECHNOLOGY CO., LTD, Shanghai (CN)

(72) Inventor: Haibing KONG, Shanghai (CN)

(73) Assignee: SHANGHAI QING FAN INTELLECTUAL SUNSHADE TECHNOLOGY CO., LTD, Shanghai (CN)

(21) Appl. No.: 19/489,274

(22) PCT Filed: Nov. 21, 2023
(86) PCT No.: PCT/CN2023/132983

§ 371 Date: Dec. 2, 2025

(30) Foreign Application Priority Data
Jun. 2, 2023 (CN) 202321393325.1

(51) Int. Cl. E06B 9/72; E06B 9/42

(52) U.S. Cl. CPC E06B 9/72; E06B 9/42

(57) ABSTRACT

The provided is a roller blind with a tensioning device, including a power source, a roller, a curtain material, a length-limiting locating element, and a tensioning device; the length-limiting locating element is used to limit the unwinding length of the curtain material, including a positioning roller; the tensioning device includes a driving medium and a driving wheel assembly; the driving wheel assembly includes a driving wheel; the driving medium is ring-shaped and wraps around the driving wheel and the positioning roller; the power source is drive-connected to the roller, and the roller is connected to the driving medium via the driving wheel assembly, ensuring the driving medium to rotate with the roller. The roller is also connected to the driving medium via the curtain material. During the unwinding process, the roller blind can maintain the curtain material to be tensioned, flat, and not drooping.

### TECHNICAL FIELD

The present invention belongs to the field of roller blind and relates to a roller blind with a tensioning device.

### BACKGROUND TECHNOLOGY

With the rapid advancement of science and technology, the concepts of life of people are gradually evolving, and the demand for sunshade products is also on the rise. Electric sunshade curtains are one of the most widely used products in this category. Most commercially available sunshade curtains are installed horizontally, and since they cannot rely on gravity to close, a retractable belt structure on both sides is typically used to roll up the curtain fabric. These retractable belts are under constant stress during curtain operation, leading to fatigue and significantly reducing the lifespan of the sunshade curtains. Additionally, there are two types of sunshade curtains on the market that use tension springs and gas springs. Their characteristic is that the tension springs and gas springs are both installed inside the draw bar. The length of the tension springs and gas springs is limited by the length of the draw bar, so the compensation distance cannot exceed the length of the draw bar. They also suffer from spring fatigue issues.

### Content of the Utility Model

To address the issues of sagging, unevenness, and lack of tension in curtain material after and during roller blind unwinding, the present invention discloses a roller blind with a tensioning device, comprising a power source, a roller, a curtain material, a length-limiting locating element, and a tensioning device; the length-limiting locating element is used to limit the unwinding length of the curtain material and includes a positioning roller; the tensioning device comprises a driving medium and a driving wheel assembly; the driving wheel assembly includes a driving wheel; the driving medium is ring-shaped and wraps around the driving wheel and the positioning roller;

The power source is drive-connected to the roller and the roller is connected to the driving medium via the driving wheel assembly, ensuring the driving medium to rotate with the roller; the roller is also connected to the driving medium via the curtain material.

In some specific embodiments, the power source is arranged inside the roller; furthermore, the power source is coaxially arranged with the roller.

In some specific embodiments, the tensioning device further comprises a synchronizing device assembly; the synchronizing device assembly comprises a housing, a friction assembly, and a shaft; the synchronizing device assembly is drive-connected to the roller;

The friction assembly comprises a first friction ring and a second friction ring; the shaft passes through the first friction ring and the second friction ring; the inner ring contour of the second friction ring is provided with a second interlocking component that matches the outer contour of the shaft, ensuring the second friction ring to rotate synchronously with the shaft; the first friction ring is in close contact with the second friction ring, and the friction force between the two drives the first friction ring and the second friction ring to rotate in the same direction; the outer ring contour of the first friction ring is provided with a first interlocking component matching the inner wall of the housing, ensuring the housing to rotate synchronously with the first friction ring; the synchronizing device assembly is drive-connected to the driving medium via the driving wheel assembly.

In some specific embodiments, the housing of the synchronizing device assembly is drive-connected to the roller; the shaft of the synchronizing device assembly is drive-connected to the driving medium via the driving wheel assembly; furthermore, the shaft and the roller are arranged on the same axis.

In some specific embodiments, the housing and the roller are integrally formed.

In some specific embodiments, the shaft of the synchronizing device assembly is drive-connected to the roller; the housing of the synchronizing device assembly is drive-connected to the driving medium via the driving wheel assembly.

In some specific embodiments, the shaft is a hollow shaft. Furthermore, the hollow shaft is an octagonal tube.

In some specific embodiments, the first interlocking component is integrally formed with the first friction ring and constitutes a portion of the first friction ring.

The second interlocking component is integrally formed with the second friction ring and constitutes a portion of the second friction ring.

In some specific embodiments, the synchronizing device assembly further comprises an adjusting assembly; the adjusting assembly regulates the friction force between the first friction ring and the second friction ring by applying pressure to the friction assembly.

In some specific embodiments, the adjusting assembly comprises an elastic element; the elastic element controls the pressure applied to the friction assembly through the elastic deformation extent, thereby regulating the friction force between the first friction ring and the second friction ring.

In some specific embodiments, the elastic elements are springs.

In some specific embodiments, the elastic element is fixed between the first friction ring and the second friction ring via set screws; the set screws are connected to the first friction ring and the second friction ring, and one or both ends of the set screws pass through the first friction ring and/or the second friction ring. Bolts are provided at one or both ends of the set screws to adjust the length of the set screws between the first friction ring and the second friction ring, thereby regulating the elastic deformation extent of the elastic element.

In some specific embodiments, the adjusting assembly further comprises a first pressure-applying member; the elastic element transmits the pressure generated by elastic deformation through the first pressure-applying member to the friction assembly.

In some specific embodiments, the outer contour of the first pressure-applying member is identical to the outer contour of the first friction ring, ensuring the first pressure-applying member to rotate with the housing.

In some specific embodiments, the first pressure-applying member is ring-shaped; the inner ring contour of the first pressure-applying member is identical to the inner ring contour of the second friction ring, so that the shaft can rotate with the first pressure-applying member.

In some specific embodiments, the adjusting assembly further comprises a second pressure-applying member; the first pressure-applying member, elastic element, and second pressure-applying member are arranged in sequence.

In some specific embodiments, the first pressure-applying member and second pressure-applying member are ring-shaped;

The outer contour of the first pressure-applying member and the outer contour of the second pressure-applying member are both identical to the outer contour of the first friction ring, ensuring the first pressure-applying member and the second pressure-applying member to rotate with the housing; or

The inner contour of the first pressure-applying member and the inner contour of the second pressure-applying member are both identical to the inner contour of the second friction ring, ensuring the shaft to rotate with the first pressure-applying member and the second pressure-applying member.

The elastic deformation extent of the elastic element is adjusted by a fastener; the fastener comprises an ejector pin; the extension and retraction of the ejector pin can cause the elastic deformation force acting on the elastic element to change, thereby adjusting the elastic deformation extent of the elastic element.

In some specific embodiments, the adjusting assembly further comprises a first pressure-applying member and a second pressure-applying member; the first pressure-applying member, the elastic element, and the second pressure-applying member are arranged in sequence; the fastener is mounted on the first pressure-applying member and/or the second pressure-applying member.

In some specific embodiments, the adjusting assembly and the friction assembly are arranged in the space enclosed by the side wall and the end plate of the housing; the ejector pin passes through the end plate of the housing; the first end of the ejector pin abuts the adjusting assembly, and the second end of the ejector pin is exposed on the outer side of the end plate and is provided with a fixture to control the length of the ejector pin extending into the inner side of the end plate. Furthermore, the fixture and the ejector pin are respectively a nut and a screw rod.

In some specific embodiments, the first interlocking component is an outwardly extending protrusion, and the inner wall of the housing is provided with a corresponding depression matching the first interlocking component; or the first interlocking component is an inwardly recessed depression, and the inner wall of the housing is provided with a corresponding protrusion matching the first interlocking component; or the first interlocking component comprises both an outwardly extending protrusion and an inwardly recessed depression, the inner wall of the housing is provided with a depression matching the outwardly extending protrusion at a corresponding position of the outwardly extending protrusion and the inner wall of the housing is provided with a protrusion matching the inwardly recessed depression at a corresponding position of the inwardly recessed depression.

In some specific embodiments, the cross-sectional inner wall contour of the housing is not circular, and the outer contour of the first friction ring matches the cross-sectional inner wall contour of the housing, ensuring the first friction ring to rotate with the housing; the first interlocking component is a portion of the outer contour of the first friction ring that matches the inner wall contour of the cross-section of the housing.

In some specific embodiments, the second interlocking component is an inwardly extending protrusion, the outer contour of the shaft is provided with a depression corresponding to the second interlocking component; or the second interlocking component is a depression that extends inward into the ring, and the outer contour of the shaft is provided with a protrusion corresponding to the second interlocking component; or the second interlocking component includes both an inwardly extending protrusion and a depression that extends inward into the ring, the outer contour of the shaft is provided with a depression corresponding to the inwardly extending protrusion at the corresponding position of the inwardly extending protrusion, and the outer contour of the shaft is provided with a protrusion corresponding to the inwardly recessed depression at the corresponding position of the inwardly recessed depression.

In some specific embodiments, the cross-sectional outer contour of the shaft is not circular, and the inner contour of the second friction ring matches the cross-sectional outer contour of the shaft, ensuring the shaft to rotate with the second friction ring; the second interlocking component is a portion of the inner contour of the second friction ring that matches the outer contour of the cross-section of the shaft, such that the inner ring contour of the second friction ring matches the outer contour of the cross-section of the shaft.

In some specific embodiments, the elastic deformation extent of the elastic element is controlled by fasteners mounted on the first pressure-applying member and/or the second pressure-applying member.

In some specific embodiments, the number of the first friction rings or second friction rings is greater than 1, and the transmission effect of the housing to the shaft is adjusted by changing the friction area through adjusting the arrangement of the first friction rings and second friction rings. When the increase in the friction area between the first friction ring and the second friction ring is required, the first friction rings and second friction rings are alternately arranged; when appropriate decrease in the friction area between the first friction ring and the second friction ring is required, the first friction ring and the second friction ring are partially alternately arranged; when maximum decrease in the friction area between the first friction ring and the second friction ring is required and the friction area is not zero, the first friction ring and the second friction ring are arranged in two queues, such that the friction area is only the contact area between 1 first friction ring and 1 second friction ring.

In some specific embodiments, the number of first friction rings and/or second friction rings is equal to or greater than 1.

In some specific embodiments, the power source is set within the roller; wires of the power source pass through the shaft to connect to a power outlet.

In some specific embodiments, the driving wheel assembly further comprises a pawl and a pawl support shaft; the driving wheel is a ratchet gear; the ratchets of the ratchet gear are inclined towards the same rotation direction and arranged around the inner circumferential surface of the ratchet gear; the front end of the pawl is positioned within the ratchets of the ratchet gear, and the root of the pawl is arranged on the outer circumferential surface of the pawl support shaft; the driving wheel assembly is configured such that: when the rotational direction of the pawl support shaft is the same as the inclination direction of the ratchets of the ratchet gear, the pawl engages within the ratchets of the ratchet gear, driving the ratchet gear and the pawl support shaft to rotate synchronously in the same direction; when the rotational direction of the pawl support shaft is opposite to the inclination direction of the ratchets of the ratchet gear, the pawl slips within the ratchets of the ratchet gear, and the ratchet gear does not rotate synchronously with the pawl support shaft; the pawl support shaft is drive-connected to the roller. Furthermore, the pawl support shaft is drive-connected to the shaft.

In some specific embodiments, in the right view of the ratchet gear, the ratchets of the ratchet gear are arranged in a clockwise inclined manner around the inner circumferential surface of the ratchet gear.

In some specific embodiments, in the right view of the ratchet gear, the ratchets of the ratchet gear are arranged in a counterclockwise inclined manner around the inner circumferential surface of the ratchet gear.

In some specific embodiments, the inclination angle of each ratchet is the same.

In some specific embodiments, the inclination angle of some or all ratchets is different.

In some specific embodiments, a spacing groove is provided on the outer circumferential surface of the ratchet support shaft; the spacing groove is connected to the ratchet via a support member; the spacing groove is used to restrict the rotational amplitude of the pawl around the support member, ensuring that the pawl can rotate within the ratchets of the ratchet gear when slipping, thereby facilitating slipping, while also ensuring that the pawl does not rotate around the support member when engaged in the ratchets of the ratchet gear and drives the ratchet gear and pawl support shaft to rotate synchronously, thereby facilitating the driving of the ratchet gear.

In some specific embodiments, the driving medium is a transmission belt, and the ratchet gear is a ratchet belt wheel that can be driven in conjunction with the transmission belt.

In some specific embodiments, the driving medium is a transmission wire, and the ratchet gear is a ratchet wire wheel that can be driven in conjunction with the transmission wire.

In some specific embodiments, the driving medium is a transmission chain, and the ratchet gear is a ratchet chain sprocket that can be driven in conjunction with the transmission chain. The outer contour of the ratchet chain sprocket is provided with bulging teeth that can engage in the gaps between the transmission chains, thereby ensuring synchronous transmission between the transmission chain and the ratchet chain sprocket without slippage.

In some specific embodiments, a roller blind with a tensioning device is configured as follows: During unwinding, the displacement length of the driving medium is balanced to be consistent with the displacement length of the curtain material through the friction force between the driving medium and the driving wheel, and/or the friction force between the roller and the driving wheel, and/or the friction force between the roller and the pawl support shaft.

In some specific embodiments, the driving wheel assembly further comprises a gear shifting assembly; the gear shifting assembly includes n gear sets, that is, the first gear set, the second gear set, and so on, up to the nth gear set, where n>1; the driving wheel assembly is configured such that the roller is drive-connected to the gear set, the gear set is drive-connected to the driving wheel, and the rotational speed of the roller, after passing through the gear sets of different gears, causes the rotational speed of the driving wheel to change. Furthermore, the shaft is drive-connected to the gear set, the gear set is drive-connected to the driving wheel, and the rotational speed of the shaft, after passing through the gear sets of different gears, causes the rotational speed of the driving wheel to change. The ellipsis here indicates an increase from 1 to n. For example, when n=4, “The first gear set . . . the nth gear set in sequence” refers to the first gear set, second gear set, third gear set, and fourth gear set in sequence. Thus, when n takes different values greater than 1, the same principle applies.

In some specific embodiments, n equals 2, 3, 4, 5, 6, 7, 8, or 9.

In some specific embodiments, the driving wheel is ring-shaped, with n rows of gear rails on its inner ring that are matched with the nth gear set; the gear set comprises at least 2 gears connected in a transmission way, that is, the driving gear and the driven gear; the driving gear is drive-connected to the roller, and the driven gear is mounted on the gear rail; the diameters of the n rows of the gear rails are different and/or the diameters of the driving gears in the nth gear set are different; the gear sets are shifted on the gear rails via a mountain bike shifting mechanism, an electromagnet mechanism, or a steering gear mechanism. Furthermore, the driving gear is drive-connected to the shaft.

In some specific embodiments, the driving medium is a transmission belt, and the driving gear is a ratchet belt wheel that can be driven in conjunction with the transmission belt.

In some specific embodiments, the driving medium is a transmission wire, and the ratchet gear is a ratchet wire wheel that can be driven in conjunction with the transmission wire.

In some specific embodiments, the driving medium is a transmission belt, and the driving gear is a drive sprocket that can be driven in conjunction with the transmission chain. The outer contour of the drive sprocket is provided with bulging teeth that can engage in the gaps between the transmission chains, thereby ensuring synchronous transmission between the transmission chain and the drive sprocket without slippage.

In some specific embodiments, the power source is set within the roller; wires of the power source pass through the hollow shaft to connect to a power outlet.

In some specific embodiments, the power source has auxiliary wheels at both ends; the driving medium also surrounds the auxiliary wheels; the power source drives the driving mediums via the auxiliary wheels, the driving mediums drive the driving wheel assembly; the driving wheel assembly then drives the roller via the synchronizing device assembly, thereby ensuring the roller to rotate and achieve the unwinding and/or winding of the curtain material.

In some specific embodiments, the power source is positioned on the axis where the positioning roller is located, driving the positioning roller to rotate, thereby driving the driving medium to rotate, the driving medium drives the driving wheel assembly, the driving wheel assembly is then rotated via the synchronizing device assembly, thereby driving the roller to rotate and achieve the unwinding and/or winding of the curtain material.

In some specific embodiments, the length-limiting locating element further comprises a side rail; the positioning roller and the driving medium are both arranged in the side rail.

In some specific embodiments, the curtain material is connected with the driving medium through the bottom rail arranged at the bottom of the curtain material.

In some specific embodiments, a roller blind with a tensioning device is configured as follows: During unwinding, the displacement length of the driving medium is balanced to be consistent with the displacement length of the curtain material through the friction force between the driving medium and the driving wheel.

In some specific embodiments, a roller blind with a tensioning device is configured as follows: During unwinding, the displacement length of the driving medium is balanced to be consistent with the displacement length of the curtain material through the friction force between the roller and the driving wheel.

In some specific embodiments, a roller blind with a tensioning device is configured as follows: During unwinding, the displacement length of the driving medium is balanced to be consistent with the displacement length of the curtain material through the friction force between the driving medium and the driving wheel.

In some specific embodiments, the tensioning device further comprises a synchronizing device assembly; the synchronizing device assembly comprises a housing, a friction assembly, and a shaft; the friction assembly comprises a first friction ring and a second friction ring; the shaft passes through the first friction ring and the second friction ring; the inner ring contour of the second friction ring is provided with a second interlocking component that matches the outer contour of the shaft, ensuring the second friction ring to rotate synchronously with the shaft; the first friction ring is in close contact with the second friction ring, and the friction force between the two drives the first friction ring and the second friction ring to rotate in the same direction; the outer ring contour of the first friction ring is provided with a first interlocking component matching the inner wall of the housing, ensuring the housing to rotate synchronously with the first friction ring;

The connection and transmission relationships of the roller blind with a tensioning device are configured to be selected from any one of the following methods: a1)-a4):

Method a1): The housing is drive-connected to the power source; the shaft is aligned with the power source on the same axis; the two ends of the roller are equipped with auxiliary wheels; the driving mediums are also mounted around the auxiliary wheels; the power source transmits power through the housing to the friction assembly and then to the shaft, the shaft drives the driving wheel assembly, and then drives the auxiliary wheels via the driving mediums, thereby rotating the roller to achieve the unwinding and/or winding of the curtain material; Method a2): The shaft is drive-connected to the power source; the shaft is aligned with the power source on the same axis; the two ends of the roller are equipped with auxiliary wheels; the driving mediums are also mounted around the auxiliary wheels; the power source transmits power through the shaft to the friction assembly and then to the housing, the housing drives the driving wheel assembly, and then drives the auxiliary wheels via the driving mediums, thereby rotating the roller to achieve the unwinding and/or winding of the curtain material;

Method a3): The housing is drive-connected to the driving wheel assembly; the roller is aligned with the power source on the same axis; the two ends of the roller are equipped with auxiliary wheels; the driving mediums are also mounted around the auxiliary wheels; the power source transmits power through the roller to the auxiliary wheels and then to the driving mediums, the driving medium drives the driving wheel assembly, thereby driving the synchronizing device assembly to rotate; the rotational speed of the driving medium is then reduced through the friction force between the first friction ring and the second friction ring.

Method a4): The shaft is drive-connected to the driving wheel assembly; the roller is aligned with the power source on the same axis; the two ends of the roller are equipped with auxiliary wheels; the driving mediums are also mounted around the auxiliary wheels; the power source transmits power through the roller to the auxiliary wheels and then to the driving mediums, the driving medium drives the driving wheel assembly, thereby driving the synchronizing device assembly to rotate; the rotational speed of the driving medium is then reduced through the friction force between the first friction ring and the second friction ring.

In some specific embodiments, the tensioning device also comprises a synchronizing device assembly; the synchronizing device assembly comprises a housing, a friction assembly, and a shaft; the housing is drive-connected to the roller; the shaft and the roller are aligned on the same axis; the power source is positioned on the axis where the positioning roller is located, driving the positioning roller to rotate, thereby driving the driving mediums to rotate; the driving mediums then drive the driving wheel assembly, the driving wheel assembly then drives the friction assembly via the shaft to rotate the housing, thereby driving the roller to rotate and achieve the unwinding and/or rewinding of the curtain material;

The friction assembly comprises a first friction ring and a second friction ring; the shaft passes through the first friction ring and the second friction ring; the inner ring contour of the second friction ring is provided with a second interlocking component that matches the outer contour of the shaft, ensuring the second friction ring to rotate with the shaft; the first friction ring is in close contact with the second friction ring, and the friction force between the two drives the first friction ring and the second friction ring to rotate; the outer ring contour of the first friction ring is provided with a first interlocking component matching the inner wall of the housing, ensuring the housing to rotate with the first friction ring.

In some specific embodiments, the radius of the curtain material wound on the roller is no greater than the radius of the driving medium on the driving wheel.

In some specific embodiments, the curtain material is connected with the driving medium through the bottom rail arranged at the bottom of the curtain material.

In some specific embodiments, the cross-sectional outer contour of the hollow shaft is octagonal, triangular, square, rectangular, hexagonal, heptagonal, elliptical, trapezoidal, pentagonal, rhombic, semicircular, or irregularly shaped. Furthermore, the cross-sectional outer contour of the hollow shaft is a regular octagon.

In some specific embodiments, the length-limiting locating elements are arranged in pairs and symmetrically; the tensioning devices are arranged in pairs and symmetrically. Furthermore, the positioning rollers are arranged in pairs and symmetrically; the one-way wheel assemblies are arranged in pairs and symmetrically; the driving mediums are arranged in pairs and symmetrically; the synchronizing device assemblies are arranged in pairs and symmetrically; and the side rails are arranged in pairs and symmetrically.

In some specific embodiments, the driving wheel comprises a first-gear driving wheel, a second-gear driving wheel, and so on, with the radii of the driving wheels decreasing in order from the first gear to the mth gear, where m>1; the driving wheels are shifted among gears via a mountain bike shifting mechanism, an electromagnet mechanism, or a steering gear mechanism, so that the driving medium can be drive-connected to driving wheels of different radii. The ellipsis here indicates an increase from 1 to m. For example, when m=4, “the first gear driving wheel . . . to the mth gear driving wheel” refers to the first gear driving wheel, second gear driving wheel, third gear driving wheel, and fourth gear driving wheel. Thus, when m takes different values greater than 1, the same principle applies.

In some specific embodiments, m is selected from 2 to 9.

In some specific embodiments, the tensioning device further comprises a synchronizing device assembly; the synchronizing device assembly comprises a housing, a friction assembly, and a shaft; the housing is drive-connected to the roller; the shaft and the roller are arranged on the same axis;

The power source has auxiliary wheels at both ends; the driving medium also surrounds the auxiliary wheels; the power source drives the driving mediums via the auxiliary wheels, the driving mediums then drive the driving wheel assembly, the driving wheel assembly then drives the friction assembly via the shaft to rotate the housing, thereby ensuring the roller to rotate and achieve the unwinding and/or winding of the curtain material.

The friction assembly comprises a first friction ring and a second friction ring; the shaft passes through the first friction ring and the second friction ring; the inner ring contour of the second friction ring is provided with a second interlocking component that matches the outer contour of the shaft, ensuring the second friction ring to rotate with the shaft; the first friction ring is in close contact with the second friction ring, and the friction force between the two drives the first friction ring and the second friction ring to rotate; the outer ring contour of the first friction ring is provided with a first interlocking component matching the inner wall of the housing, ensuring the housing to rotate with the first friction ring.

In some specific embodiments, the tensioning device further comprises a synchronizing device assembly; the synchronizing device assembly comprises a housing, a friction assembly, and a shaft; the housing is drive-connected to the power source; the shaft and the power source are arranged on the same axis;

The roller has auxiliary wheels at both ends; the driving medium also surrounds the auxiliary wheels; the power source transmits to the friction assemblies via the housing, which in turn drive the driving wheel assembly via the shaft; thereby ensuring the auxiliary wheel to rotate via the driving medium, driving the roller to rotate and achieving the unwinding and/or winding of the curtain material.

The friction assembly comprises a first friction ring and a second friction ring; the shaft passes through the first friction ring and the second friction ring; the outer ring contour of the first friction ring is provided with a first interlocking component that matches the inner wall of the housing, ensuring the first friction ring to rotate with the housing; the first friction ring is in close contact with the second friction ring, and the friction force between the two drives the second friction ring to rotate with the first friction ring; the inner ring contour of the second friction ring is provided with a second interlocking component matching the outer contour of the shaft, ensuring the shaft to rotate with the second friction ring;

In some specific embodiments, the tensioning device further comprises a synchronizing device assembly; the synchronizing device assembly comprises a housing, a friction assembly, and a shaft; the shaft or housing is drive-connected to the driving wheel assembly;

The friction assembly comprises a first friction ring and a second friction ring; the shaft passes through the first friction ring and the second friction ring; the outer ring contour of the first friction ring is provided with a first interlocking component that matches the inner wall of the housing, ensuring the first friction ring to rotate with the housing or the housing to rotate with the first friction ring; the first friction ring is in close contact with the second friction ring, and the friction force between the two drives the second friction ring to rotate with the first friction ring or the first friction ring to rotate with the second friction ring; the inner wall contour of the second friction ring is provided with a second interlocking component matching the outer contour of the shaft, ensuring the shaft to rotate with the second friction ring or the second friction to rotate with the shaft;

The roller is aligned with the power source on the same axis; the two ends of the roller are equipped with auxiliary wheels; the driving mediums are also mounted around the auxiliary wheels; the power source transmits power through the roller to the auxiliary wheels and then to the driving mediums, the driving medium drives the driving wheel assembly, thereby driving the synchronizing device assembly to rotate; the rotational speed of the driving medium is then reduced through the friction force between the first friction ring and the second friction ring.

### Benefits of the Present Invention

1. The tensioning device is arranged to keep the curtain material in constant tensioned state after and during unwinding. Whether the friction force between the driving mediums and the driving wheels, the friction force between the roller and the driving wheels, or the friction force between the roller and the ratchet support shaft is utilized, the tensioning device ensures that the displacement length of the driving mediums aligns with the displacement length of the curtain material, thereby maintaining the curtain material in a taut state during unwinding. Especially when a synchronizing device assembly is installed, the tensioning effect is even better, without abrasion of the driving mediums or other parts.
2. The synchronizing device assembly is so configured that the length of the curtain material wound and unwound by the roller always is synchronized with the running length of the side rail, keeps the curtain material tensioned, flat and not drooping, and also ensures that the curtain material roll formed during the winding process of the curtain material to the roller is neat and each circle is tight uniformly.
3. The ratchet gear, pawl and pawl support shaft are configured such that: when the rotational direction of the pawl support shaft is the same as the inclination direction of the ratchets of the ratchet gear, the pawl engages within the ratchets of the ratchet gear, driving the ratchet gear and the pawl support shaft to rotate synchronously in the same direction; when the rotational direction is opposite to the inclination direction of the ratchets of the ratchet gear, the pawl slips within the ratchets of the ratchet gear, and the ratchet gear does not rotate synchronously with the pawl support shaft. Thereby the unidirectional transmission of the one-way wheel assembly is realized.

The roller blind in the present invention can keep the curtain material tensioned, flat and not drooping the winding and unwinding (especially unwinding) process, has good user experience, and can be widely applied to various scenes where the roller blind is mounted on the top surface, inclined surface or facade and inverse installation (moving down for turnoff stands for positive installation, moving down for turnoff stands for inverse installation) is required.

The concept, specific structure and technical effects of the present invention will be further explained in combination with the drawings, so as to fully understand the purpose, characteristics and effects of the invention.

### DESCRIPTION OF THE DRAWINGS

FIG. 1 is a local perspective structural diagram of one example of the roller blind with a tensioning device according to the present invention.

FIG. 2 is a structural diagram of one example of the roller blind with a tensioning device according to the present invention.

FIG. 3 is an exploded view of one example of the synchronizing device assembly of the present invention.

FIG. 4 is a structural diagram of one example of the synchronizing device assembly of the present invention.

FIG. 5 is an appearance and structure diagram of one example of the synchronizing device assembly of the present invention.

FIG. 6 is a local structural diagram of one example of the roller blind with a tensioning device according to the present invention.

FIG. 7 is a sectional view of the hollow shaft in Example 1 of the present invention.

FIG. 8 is a local structural diagram of one example of the roller blind with a tensioning device comprising a one-way assembly according to the present invention.

FIG. 9 is a local structural diagram of one example of the roller blind with a tensioning device comprising a one-way assembly and synchronizing device assembly according to the present invention.

FIG. 10 is a right view of ratchet gear in one example of the roller blind with a tensioning device according to the present invention.

FIG. 11 is a local structural diagram of Example 10 of the roller blind with a tensioning device comprising a gear shifting assembly according to the present invention.

FIG. 12 is a local structural diagram of one example of the roller blind with a tensioning device comprising a driving medium and a ratchet gear according to the present invention.

FIG. 13 is a structural diagram of Example 11 of the roller blind with a tensioning device concealing curtain material, roller and other parts according to the present invention.

FIG. 14 is a structural diagram of Example 15 concealing curtain material and roller to illustrate the power source positioned on the axis where the positioning roller is located.

FIG. 15 is a structural diagram of Example 15, showing the power source positioned on the axis where the positioning roller is located.

FIG. 16 is a local structural diagram of Example 16.

FIG. 17 is a structural diagram of Example 18.

FIG. 18 is a local structural diagram of Example 18.

FIG. 19 is a structural diagram of Example 19.

FIG. 20 is a local structural diagram of Example 19.

### SPECIFIC IMPLEMENTATIONS

It should be understood that the terms used herein, the specific structures and functional details disclosed, are merely for the purpose of describing embodiments and are representative, but the present application can be specifically implemented in many alternative forms and should not be interpreted as being limited to the embodiments described herein.

In the description of the present application, the terms “first” and “second” are used solely for descriptive purposes and should not be understood as indicating relative importance or implying the number of technical features indicated. Thus, unless otherwise specified, features defined as “first” or ‘second’ may explicitly or implicitly include one or more such features; “a plurality” means two or more. The term “including” and any variations thereof mean non-exclusive containing, and may include or add one or more other features, integers, steps, operations, units, components, and/or their combinations.

Additionally, terms such as “center,” “lateral,” “upper,” “lower,” “left,” “right,” “vertical,” “horizontal,” “top,” and other terms indicating direction or positional relationships are described based on the directions or relative positions shown in the drawings, solely for the purpose of simplifying the description of the invention, and are not intended to indicate that the devices or components referred to must have a specific direction or must have a specific directional structure or operation. Therefore, they should not be construed as limiting the scope of the invention.

In addition, unless otherwise explicitly specified and limited, the terms “installation,” “connected,” and “connection” should be interpreted broadly. For example, they may refer to fixed connections, removable connections, or integral connections; mechanical connections or electrical connections; direct connections or indirect connections via an intermediate medium; or internal connections between two elements. For those skilled in the art, the specific meanings of the above terms in the context of the present invention may be understood based on the specific circumstances.

### Example 1

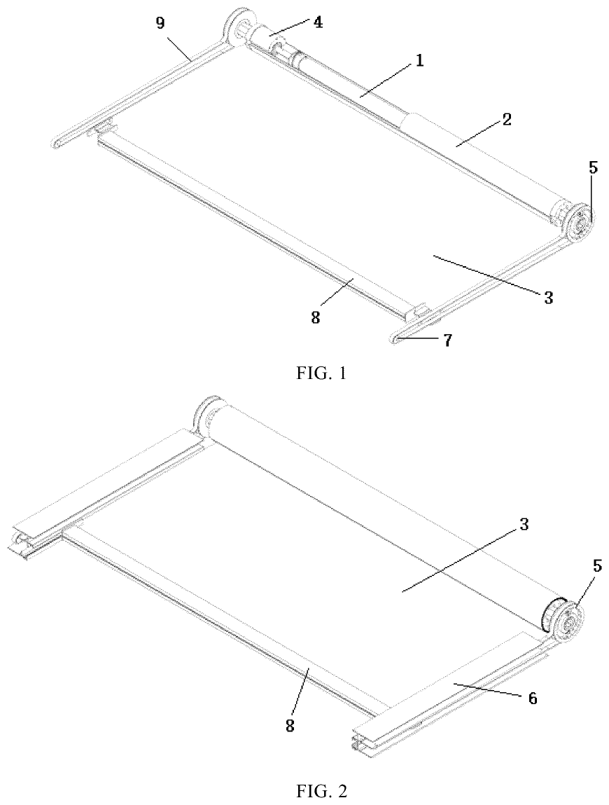

As shown in FIG. 1 and FIG. 2, the present embodiment discloses a roller blind with a tensioning device, including a power source 1, a roller 2, a curtain material 3, a length-limiting locating element, and a tensioning device.

The length-limiting locating element is used to limit the unwinding length of the curtain material 3 and includes a positioning roller 7 and a side rail 6. The tensioning device includes a one-way wheel assembly 5, a driving medium 9, and a synchronizing device assembly 4. The positioning roller 7 and the driving medium 9 are both mounted within the side rail 6.

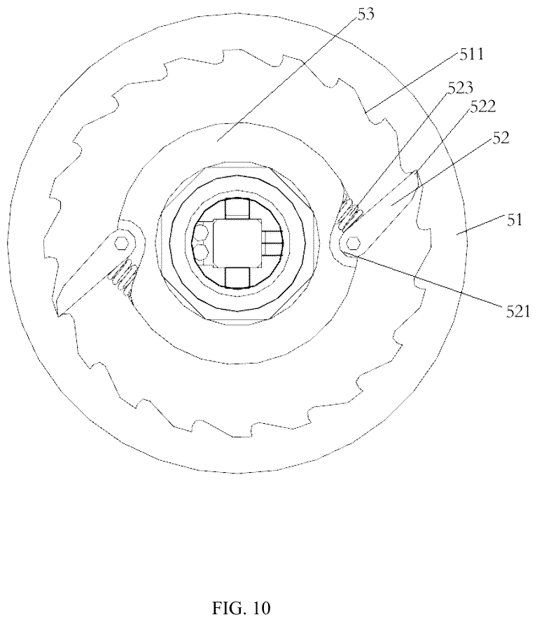

As shown in FIG. 8, the one-way wheel assembly 5 includes a driving wheel 51, a pawl 52, and a pawl support shaft 53. In this example, the driving wheel 51 is a ratchet gear. The ratchets 511 of the ratchet gear are inclined towards the same rotation direction and arranged around the inner circumferential surface of the driving wheel 51 (i.e., inclined towards the same rotation direction and arranged around), the front end 522 of the pawl is positioned within the ratchet 511 of the ratchet gear, and the root 521 of the pawl is mounted on the outer circumferential surface of the pawl support shaft 53. The one-way wheel assembly 5 is configured such that: when the rotational direction of the ratchet support shaft 53 is the same as the inclination direction of the ratchet 511 of the ratchet gear, the pawl 52 engages with the ratchet 511 of the ratchet gear, driving the driving wheel 51 to rotate synchronously with the ratchet support shaft 53 in the same direction; when the rotational direction of the ratchet support shaft 53 is opposite to the inclination direction of the ratchet 511 of the ratchet gear, the pawl 52 slips within the ratchet 511 of the ratchet gear, and the driving wheel 51 does not rotate synchronously with the ratchet support shaft 53. In the right view of the ratchet gear (FIG. 10), the ratchet 511 of the ratchet gear are arranged in a counterclockwise inclined ring pattern around the inner circumferential surface of the ratchet gear, and each ratchet has the same inclination angle.

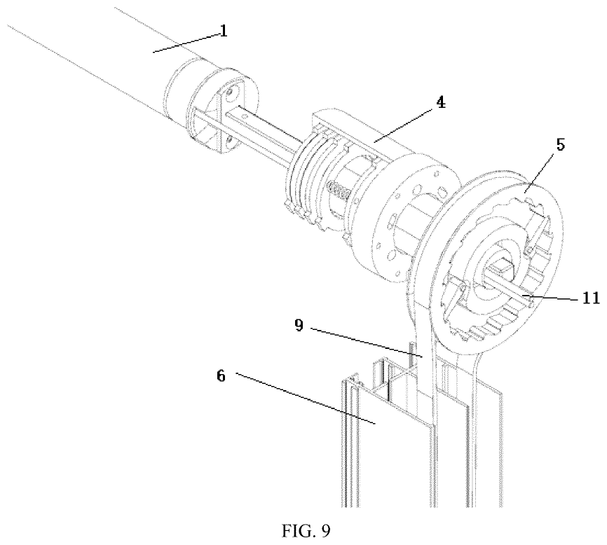

The driving medium 9 is ring-shaped and wraps around the driving wheel 51 and the positioning roller 7; the power source 1 is drive-connected to the shaft 2, and the shaft 2 is connected to the driving medium 9 via the curtain material 3. The curtain material 3 is connected to the driving medium 9 via the bottom rail 8 installed at the bottom of the curtain material 3. In this example, the driving medium 9 is a conveyor belt; the driving wheel 51 is a ratchet belt wheel. The power source 1 is a motor, including a rotor and a stator. The wires 11 of power source 1 pass through the hollow shaft 47 for connection to a power outlet. The wires 11 on the stator (FIG. 9) are connected to the alternating current from the power outlet, and when the switch is turned on, an electromagnetic field is generated, causing the rotor to rotate and driving the roller 2 connected to the rotor to rotate.

The outer circumferential surface of the ratchet support shaft 53 is provided with a spacing groove; the spacing groove is connected to the ratchet 52 via the support member 523 (FIG. 8). The spacing groove is used to restrict the rotational amplitude of the pawl 52 around the support member 523, ensuring that the pawl can rotate within the ratchet 511 of the ratchet gear when slipping, thereby facilitating slipping, while also ensuring that the pawl 52 does not rotate around the support member when it is engaged in the ratchet 511 of the ratchet gear and drives the driving wheel 51 and pawl support shaft 53 to rotate synchronously, thereby facilitating the driving of the driving wheel 51.

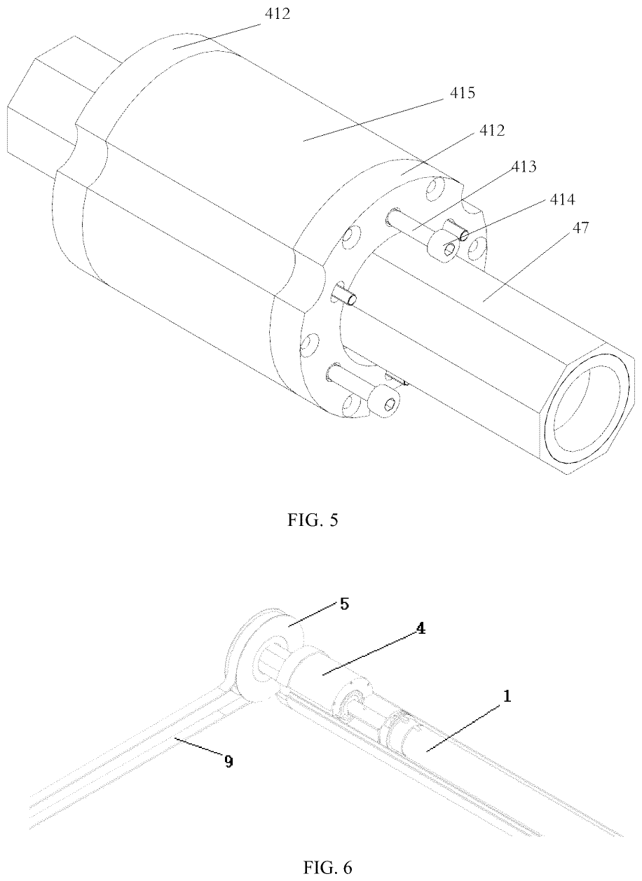

As shown in FIGS. 1, 3-6 and 5, the synchronizing device assembly 4 includes a housing, a friction assembly, an adjusting assembly and a hollow shaft 47. The adjusting assembly and the friction assembly are both arranged in the housing; the housing is drive-connected to the roller 2; the housing is drive-connected to the hollow shaft 47 through the friction assembly. The friction assembly includes a first friction ring 42 and a second friction ring 43; the hollow shaft 47 passes through the first friction ring 42 and the second friction ring 43. The outer ring contour of the first friction ring 42 is provided with a first interlocking component 421, here, a protrusion extending outward; the first interlocking component 421 is matched with the depression 411 arranged at the corresponding position on the inner wall of the housing, so that the housing rotates synchronously with the first friction ring 42 (for example, the first friction ring 42 can rotate with the housing). The first friction ring 42 abuts against the second friction ring 43, and the first friction ring 42 is driven to rotate with the second friction ring 43 through the friction between the two.

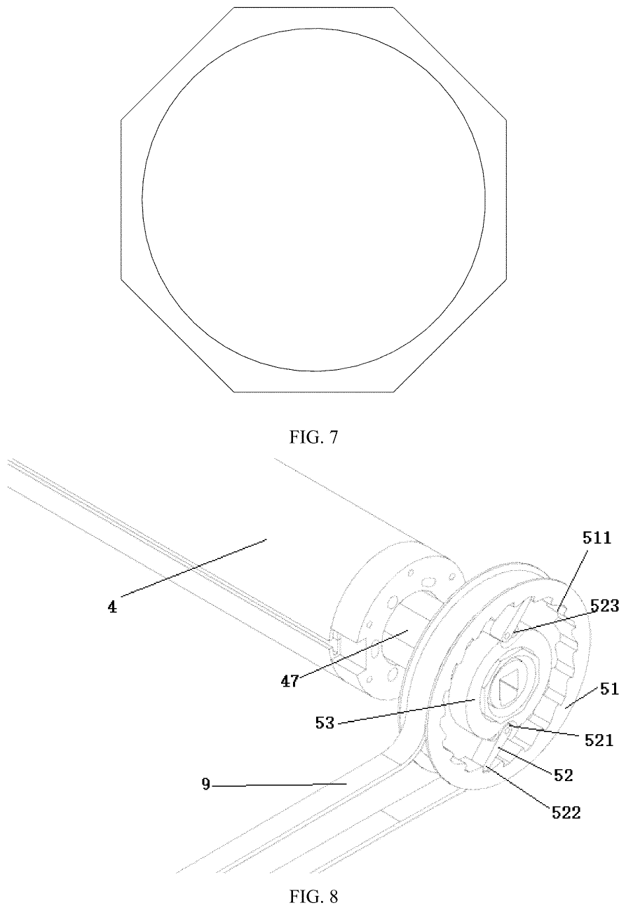

The outer contour of the cross section of the hollow shaft 47 is a regular octagon (therefore, the hollow shaft 47 in this embodiment is also called an octagonal tube, as shown in FIG. 7). The inner contour of the second friction ring 43 matches the outer contour of the cross section of the hollow shaft 47, so that the hollow shaft 47 can rotate with the second friction ring 43. Alternatively, the inner ring contour of the second friction ring 43 is provided with a second interlocking component that matches the outer contour of the hollow shaft 47, ensuring the second friction ring 43 to rotate synchronously with the shaft (e.g., allowing the hollow shaft 47 to rotate with the second friction ring 43), where the second interlocking component is a portion of the inner contour of the second friction ring 43 that matches the outer contour of the cross-section of the hollow shaft 47. For example, the cross-section of the inner ring contour of the second friction ring 43 is circular, but due to the presence of the second interlocking component, the cross-section of the inner contour of the second friction ring 43 becomes a regular octagon that matches the outer contour of the cross-section of the hollow shaft 47.

The first friction ring 42 abuts against the second friction ring 43, and the first friction ring 42 is driven to rotate with the second friction ring 43 in the same direction through the friction between the two. The adjusting assembly regulates the friction force between the first friction ring and the second friction ring by applying pressure to the friction assembly. The hollow shaft 47 is connected to the ratchet support shaft 53, ensuring the ratchet support shaft 53 to rotate with the hollow shaft 47.

The adjusting assembly comprises a first pressure-applying member 44, an elastic element 45, and a second pressure-applying member 46 arranged in sequence; the adjusting assembly adjusts the pressure applied to the friction assembly by altering the extension of the elastic element 45, thereby regulating the friction force between the first friction ring 42 and the second friction ring 43. The outer contour of the first pressure-applying member 44 and the outer contour of the second pressure-applying member 46 are both identical to the outer contour of the first friction ring 42, ensuring the first pressure-applying member 44 and the second pressure-applying member 46 to rotate with the housing. The first pressure-applying member 44 and second pressure-applying member 46 are ring-shaped. The fastener is a bolt structure. The first friction ring 42, second friction ring 43, first pressure-applying member 44, and/or second pressure-applying member 46 utilize linings.

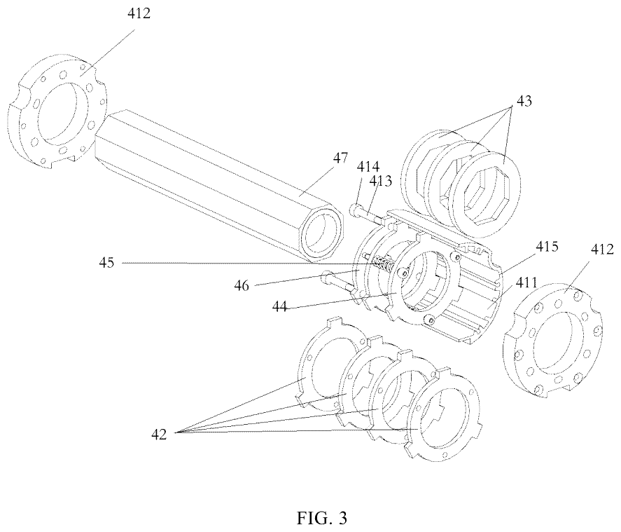

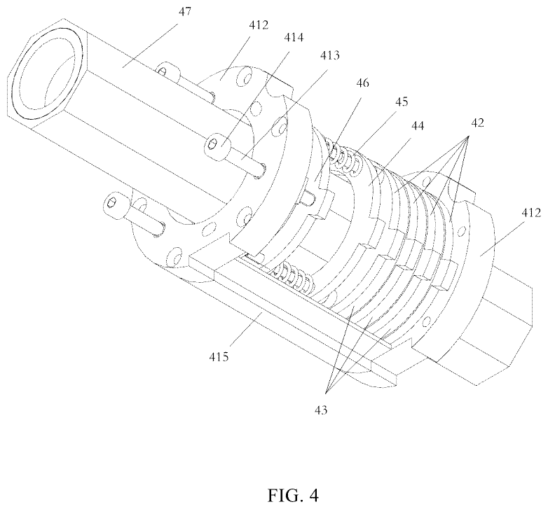

The elastic element 45 is a spring. The elastic deformation extent of the elastic element 45 is adjusted by fasteners. The fasteners include an ejector pin 413 and a fixture 414. The extension extent of the ejector pin 413 can cause the elastic deformation force acting on the elastic element 45 to change, thereby adjusting the elastic deformation extent of the elastic element 45. The adjusting assembly and friction assembly are arranged in the space enclosed by the side wall 415 and end plate 412 of the housing. The ejector pin 413 passes through the end plate 412 of the housing. The first end of the ejector pin 413 abuts the adjusting assembly, while the second end of the ejector pin 413 extends beyond the outer side of the end plate 412 and is equipped with a fixture 414 to control the length of the ejector pin 413 extending into the inner side of the end plate 412. In this example, the fixture 414 and the ejector pin 413 are respectively nuts and bolts (FIGS. 3 and 4), with a quantity of three each.

The number of the first friction rings 42 and second friction rings 43 is greater than 1, and the transmission effect of the housing to the hollow shaft is adjusted by changing the friction area through adjusting the arrangement of the first friction rings and second friction rings. In this example, there are four first friction rings 42 and three second friction rings 43, but the number of these components is not limited to this in the present invention.

When the increase in the friction area between the first friction ring 42 and the second friction ring 43 is required, the first friction rings 42 and second friction rings 43 are alternately arranged; when appropriate decrease in the friction area between the first friction ring 42 and the second friction ring 43 is required, the first friction ring 42 and the second friction ring 43 are partially alternately arranged; when it is necessary to minimize the friction area between the first friction ring 42 and the second friction ring 43 while ensuring that the friction area is not zero, the first friction ring 42 and the second friction ring 43 are arranged in two groups, such that the friction area is only the contact area between one first friction ring 42 and one second friction ring 43. In most cases in this example, the first friction ring 42 and the second friction ring 43 are fully alternately arranged, as shown in FIG. 4.

The length-limiting locating elements are arranged in pairs and symmetrically; the tensioning devices are arranged in pairs and symmetrically. Furthermore, the positioning rollers 7 are arranged in pairs and symmetrically; the one-way wheel assemblies 5 are arranged in pairs and symmetrically; the driving mediums 9 are arranged in pairs and symmetrically; the synchronizing device assemblies 4 are arranged in pairs and symmetrically; and the side rails 6 are arranged in pairs and symmetrically. In this example, the radius (r_{curtain material}) of the curtain material 3 on the roller 2 is less than or equal to the radius (r_{driving medium}) of the driving medium 9 on the driving wheel 51; it should be understood that when the curtain material 3 is wound onto the roller 2, the maximum value of r_{curtain material} does not exceed r_{driving medium}. The one-way wheel assembly 5 only slips when rotating in the winding direction. When rotating in the unwinding direction, the pawl 52 engages with the ratchet 511 of the ratchet gear, driving the ratchet gear to rotate. In this example, since in the right view of the ratchet gear, the ratchets 511 of the ratchet gear are arranged in a counterclockwise inclined manner around the inner circumferential surface of the driving wheel 51, and each ratchet has the same inclination angle. Therefore, in this example, the unwinding direction is the counterclockwise direction in the right view of the ratchet gear, and the winding direction is the clockwise direction in the right view of the ratchet gear. In other examples, the unwinding and winding directions are not limited to those described in Example 1.

Unwinding Process of a Roller Blind with a Tensioning Device:

The power source drives the roller to rotate, causing the curtain material wound on the roller to unwind. The length of the unwound curtain material (L_{unwinding}) equals the roller speed (vᵣₒₗₗₑᵣ) multiplied by time (t) multiplied by 2π radius of the curtain material on the roller (r_{curtain material}), as shown in Formula 1. Note: The rotational speed referred to in present invention denotes the number of revolutions per unit time, and thus the circumference per circle should be multiplied by.

$${L}_{undwinding} = {v}_{roller} \times t \times 2 π {r}_{curtainmaterial} \qquad Formula 1$$

At the same time, the roller drives the housing, the housing drives the first friction ring, the first friction ring drives the second friction ring due to friction, the second friction ring drives the hollow shaft, the hollow shaft drives the pawl support shaft, the pawl support shaft drives the pawl, and the pawl drives the driving wheel (in this example, the driving wheel is a ratchet gear), the driving wheel drives the driving medium, the driving medium drives the bottom rail to pull out the curtain material, and the length of the curtain material pulled out (L′_{unwinding}) equals the driving wheel speed (v_{driving wheel}) multiplied by time (t) multiplied by 271 radius of the driving medium on the driving wheel (r_{driving medium}), i.e., Formula 2.

$${L}_{undwinding}^{′} = {v}_{driving wheel} \times t \times 2 π {r}_{driving medium} \qquad Formula 2$$

The t in Formulas 1 and 2 is always synchronized, the same. When the friction assembly does not slip, the V_{driving wheel} is equal to the Vᵣₒₗₗₑᵣ, and if the r_{driving medium} is equal to the r_{curtain material}, the L_{unwinding} is equal to the L′_{unwinding}. As the unwinding time goes on, the radius of the curtain material on the roller will become smaller and smaller, that is, r_{curtain material} is a variable, ensuring L′_{unwinding} to be different from L unwinding, thus generating tension on the curtain material, making the curtain material in a tense state, not drooping and flat. Suppose that at the beginning of unwinding, the r_{curtain material} is equal to the r_{driving medium}, and the L_{unwinding} is equal to the L′_{unwinding}. As the unwinding time goes on, the r_{curtain material} gradually becomes smaller, so that the L_{unwinding} is smaller than the L′_{unwinding}, and the curtain material is continuously tensioned, that is, the curtain material is continuously strained. When the r_{curtain material} is less than the r_{driving medium}, the pulling force of the bottom rail on the curtain material is greater than the friction force between the first friction ring and the second friction ring, slippage occurs between the first friction ring and the second friction ring, and the V_{driving wheel} is smaller than the Vᵣₒₗₗₑᵣ, so that the L_{unwinding} is equal to the L′_{unwinding}.

Winding process of a roller blind with a tensioning device: The power source drives the roller to rotate, causing the curtain material wound on the roller to wind. The length of the wound curtain material (L_{winding}) equals the roller speed (vᵣₒₗₗₑᵣ) multiplied by time (t′) multiplied by 2π radius of the curtain material on the roller (r_{curtain material}), as shown in Formula 3.

$${L}_{winding} = {v}_{roller}^{′} \times t \times 2 π {r}_{curtain material} \qquad Formula 3$$

At the same time, the roller drives the housing, the housing drives the first friction ring, the first friction ring drives the second friction ring due to friction, the second friction ring drives the hollow shaft, the hollow shaft drives the pawl support shaft, the pawl support shaft drives the pawl, and the pawl drives the driving wheel when the pawl does not slip, the driving wheel drives the driving medium, the driving medium drives the bottom rail to wind the curtain material, and the length of the curtain material wound (L′_{winding}) equals the driving wheel speed (v′_{driving wheel}) multiplied by time (t′) multiplied by 2π radius of the driving medium on the driving wheel (r_{driving medium}), i.e., Formula 4.

$${L}_{winding}^{′} = {v}_{driving wheel}^{′} \times {t}^{′} \times 2 π {r}_{driving medium} \qquad Formula 4$$

The t in Formulas 3 and 4 is always synchronized, the same. In this example, the radius (r_{curtain material}) of the curtain material on the roller is less than or equal to the radius (r_{driving medium}) of the driving medium on the driving wheel; when the curtain material is wound onto the roller, the maximum value of r_{curtain material} does not exceed r_{driving medium}, and therefore, in the initial stage of winding, the r_{curtain material} must be smaller than the r_{driving medium}. According to Formulas 3 and 4, L′_{winding} tends to be greater than L_{winding}, and this inevitably causes the curtain material to wrinkle.

However, due to the configuration of the one-way wheel assembly, winding causes the pawl to slip, resulting in v′_{driving wheel} being less than v′ᵣₒₗₗₑᵣ, thereby maintaining L′_{winding} equal to L_{winding}. Alternatively, the pawl slipping may cause the pawl to completely fail to drive the driving wheel. The driving medium is pulled by the bottom rail, and the driving medium drives the driving wheel to move, thereby continuing to maintain L′_{winding} equal to L_{winding}.

### Example 2

In this example, in the right view of the ratchet gear, the ratchets of the ratchet gear are arranged in a clockwise inclined manner around the inner circumferential surface of the ratchet gear. The remaining structure is the same as in Example 1. The unwinding and winding process is similar to that of Example 1, except that the unwinding direction and the winding direction are different.

### Example 3

In this example, the inclination angle of some or all ratchets is different. The remaining is the same as in Example 1.

### Example 4

In this example, the roller blind with a tensioning device does not include a synchronizing device assembly. The function of the synchronizing device assembly is achieved through friction slippage by allowing the driving mediums and ratchet gears to rotate coaxially. Specifically, the power source transmits power to the roller, then the roller performs the unwinding or winding of the curtain material, the rotation of the roller drives the pawl support shaft to rotate simultaneously, and then drives the pawl and ratchet gear to rotate; the ratchet gear drives the driving mediums mounted on it to transmit power, thereby unwinding or winding the curtain material connected to the bottom rail. In this comparative embodiment, to achieve a synchronized speed between the roller unwinding/winding of the curtain material and the side rail unwinding/winding of the curtain material, friction slippage occurs between the driving medium and the ratchet gear to achieve the synchronizing function of the synchronizing device assembly in Example 1. However, this embodiment is inferior to Example 1 in that the friction between the driving medium and the ratchet gear generates high temperatures, and the excessive heat causes the driving medium to soften, thereby accelerating the wear of the driving medium. Therefore, slippage of the driving medium can achieve the tensioning purpose but this leads to rapid wear and a short service life of the driving medium. The purpose of using a single synchronizing device assembly in Example 1 is to extend the service life of the roller blind equipped with a tensioning device by leveraging the wear resistance of the friction assembly (for example, the first friction ring, second friction ring, first pressure-applying member, and/or second pressure-applying member all use linings). This approach is considered from the perspective of product lifespan. The remaining structure is the same as in Example 1.

Unwinding Process of a Roller Blind with a Tensioning Device:

The roller drives the pawl support shaft. When the r_{curtain material} is less than the r_{driving medium} so that the pulling force of the bottom rail on the curtain material is greater than the friction force between the driving medium and the ratchet gear, slippage occurs between the driving medium and the ratchet gear, and the V_{driving wheel} is smaller than the Vᵣₒₗₗₑᵣ, so that the L_{unwinding} is equal to the L′_{unwinding}. The remaining unwinding process is the same as in Example 1.

Winding Process of a Roller Blind with a Tensioning Device:

The roller drives the pawl support shaft. The bottom rail pulls the driving medium, and although slippage may occur between the driving medium and the ratchet gear, the movement of the driving medium can still maintain L_{winding} equal to L′_{winding}. The remaining winding process is the same as in Example 1.

### Example 5

In this example, the adjusting assembly includes a first pressure-applying member, an electromagnetic relay, and a second pressure-applying member. The adjusting assembly adjusts the distance between the first pressure-applying member and the second pressure-applying member via the electromagnetic relay to change the pressure applied by the adjusting assembly to the friction assembly, thereby adjusting the friction force between the first friction ring and the second friction ring. The distance between the first pressure-applying member and the second pressure-applying member changes with the electromagnetic field generated by the electromagnetic relay. The remaining is the same as in Example 1.

### Example 6

In this example, the fastener is a perforated pin structure; the distance between the first pressure-applying member and the second pressure-applying member is adjusted based on the distance between the holes on the rod inserted between the first pressure-applying member and the second pressure-applying member to change the pressure applied by the adjusting assembly to the friction assembly, thereby adjusting the friction force between the first friction ring and the second friction ring. The remaining is the same as in Example 1.

### Example 7

In this example, the first interlocking component is an inwardly recessed depression, and the inner wall of the housing is provided with a protrusion corresponding to the first interlocking component at the corresponding position; the second interlocking component is an inwardly extending protrusion, and the outer contour of the hollow shaft is provided with a depression corresponding to the second interlocking component at the corresponding position. The remaining is the same as in Example 1.

### Example 8

In this example, the first interlocking component comprises both an outwardly extending protrusion and an inwardly recessed depression, the inner wall of the housing is provided with a depression matching the outwardly extending protrusion at a corresponding position of the outwardly extending protrusion and the inner wall of the housing is provided with a protrusion matching the inwardly recessed depression at a corresponding position of the inwardly recessed depression. The remaining is the same as in Example 1.

### Example 9

In this example, the cross-sectional inner wall contour of the housing is not circular, and the outer contour of the first friction ring matches the cross-sectional inner wall contour of the housing, ensuring the first friction ring to rotate with the housing; the first interlocking component is a portion of the outer contour of the first friction ring that matches the inner wall contour of the cross-section of the housing. The second interlocking component includes both an inwardly extending projection and a depression recessing inwardly into the ring. The outer contour of the hollow shaft is provided with a depression matching the inwardly extending protrusion at the corresponding position of the inwardly extending protrusion. The outer contour of the hollow shaft is provided with a protrusion matching the depression recessing inwardly into the ring at the corresponding position of the depression recessing inwardly into the ring. The remaining is the same as in Example 1.

### Example 10

In this example (FIG. 11), the driving wheel assembly does not include a pawl and pawl support shaft, but includes a gear shifting assembly; the gear shifting assembly includes n gear sets, that is, the first gear set, the second gear set, and so on, up to the nth gear set, where n>1; the driving wheel assembly is configured such that the hollow shaft 47 is drive-connected to the gear set, the gear set is drive-connected to the driving wheel 5, and the rotational speed of the hollow shaft 47, after passing through the gear sets of different gears, causes the rotational speed of the driving wheel 5 to change. The driving wheel 5 is ring-shaped, with n rows of gear rails 61 on its inner ring that are matched with the nth gear set; the gear set comprises at least two gears connected in a transmission way, that is, the driving gear 62 and the driven gear 63; the driving gear 62 is drive-connected to the hollow shaft 47, and the driven gear 63 is mounted on the gear rail 61; the diameters of the n rows of the gear rails are different and/or the diameters of the driving gears in the nth gear set are different. In this example, n=2. The remaining structure is the same as in Example 1.

Unwinding Process of a Roller Blind with a Tensioning Device:

The power source drives the roller to rotate, causing the curtain material wound on the roller to unwind. The length of the unwound curtain material (L_{unwinding}) equals the roller speed (vᵣₒₗₗₑᵣ) multiplied by time (t) multiplied by 2π radius of the curtain material on the roller (r_{curtain material}), as shown in Formula 1.

$${L}_{undwinding} = {v}_{roller} \times t \times 2 π {r}_{curtain material} \qquad Formula 1$$

At the same time, the roller drives the housing, the housing drives the first friction ring, the first friction ring drives the second friction ring due to friction, the second friction ring drives the hollow shaft, the hollow shaft drives the gear set, the gear set drives the driving wheel, the driving wheel drives the driving medium, the driving medium drives the bottom rail to pull out the curtain material, and the length of the curtain material pulled out (L′_{unwinding}) equals the driving wheel speed (v_{driving wheel}) multiplied by time (t) multiplied by 2π radius of the driving medium on the driving wheel (r_{driving medium}), i.e., Formula 2.

$${L}_{undwinding}^{′} = {v}_{driving wheel} \times t \times 2 π {r}_{driving medium} \qquad Formula 2$$

The t in Formulas 1 and 2 is always synchronized, the same. When the friction assembly does not slip, the V_{driving wheel} is equal to the Vᵣₒₗₗₑᵣ, and if the r_{driving medium} IS equal to the r_{curtain material}, the L_{unwinding} is equal to the L′_{unwinding}. As the unwinding time goes on, the radius of the curtain material on the roller will become smaller and smaller, that is, r_{curtain material} is a variable, ensuring L′_{unwinding} to be not equal to L_{unwinding}, thus generating tension on the curtain material, making the curtain material in a tense state, not drooping and flat. Suppose that at the beginning of unwinding, the r_{curtain material} is equal to the r_{driving medium}, the L_{unwinding} is equal to the L′_{unwinding}. As the unwinding time goes on, the r_{curtain material} gradually becomes smaller, so that the L_{unwinding} is smaller than the L′_{unwinding}, and the curtain material is continuously tensioned, that is, the curtain material is continuously strained. When the r_{curtain material} is less than the r_{driving medium}, the pulling force of the bottom rail on the curtain material is greater than the friction force between the first friction ring and the second friction ring, slippage occurs between the first friction ring and the second friction ring, and the V_{driving wheel} is smaller than the Vᵣₒₗₗₑᵣ, so that the L_{unwinding} is equal to the L′_{unwinding}.

Winding Process of a Roller Blind with a Tensioning Device:

The power source drives the roller to rotate, causing the curtain material wound on the roller to wind. The length of the wound curtain material (L_{winding}) equals the roller speed (v′ᵣₒₗₗₑᵣ) multiplied by time (t′) multiplied by 271 radius of the curtain material on the roller (r_{curtain material}), as shown in Formula 3.

$${L}_{winding} = {v}_{roller}^{′} \times {t}^{′} \times 2 π {r}_{curtain material} \qquad Formula 3$$

At the same time, the roller drives the housing, the housing drives the first friction ring, the first friction ring drives the second friction ring due to friction, the second friction ring drives the hollow shaft, the hollow shaft drives the pawl support shaft, the pawl support shaft drives the pawl, and the pawl drives the driving wheel when the pawl does not slip, the driving wheel drives the driving medium, the driving medium drives the bottom rail to wind the curtain material, and the length of the curtain material wound (L′_{winding}) equals the driving wheel speed (v′_{driving wheel}) multiplied by time (t′) multiplied by 2π radius of the driving medium on the driving wheel (r_{driving medium}), i.e., Formula 4.

$${L}_{winding}^{′} = {v}_{driving wheel}^{′} \times {t}^{′} \times 2 π {r}_{driving medium} \qquad Formula 4$$

The t in Formulas 3 and 4 is always synchronized, the same. In this example, the radius (r_{curtain material}) of the curtain material on the roller is less than or equal to the radius (r_{driving medium}) of the driving medium on the driving wheel; when the curtain material is wound onto the roller, the maximum value of r_{curtain material} does not exceed r_{driving medium}, and therefore, in the initial stage of winding, the r_{curtain material} must be smaller than the r_{driving medium}. According to Formulas 3 and 4, L′_{winding} tends to be greater than L_{winding}, and this inevitably causes the curtain material to wrinkle. However, due to the configuration of the n-gear set and the n rows of gear rails on the inner ring of the driving wheel, the operator can adjust different gears based on different speeds to obtain an appropriate v′_{driving wheel}, ensuring that v′_{ratchet gear} is less than v′ᵣₒₗₗₑᵣ, thereby maintaining L′_{winding} equal to L_{winding}.

### Example 11

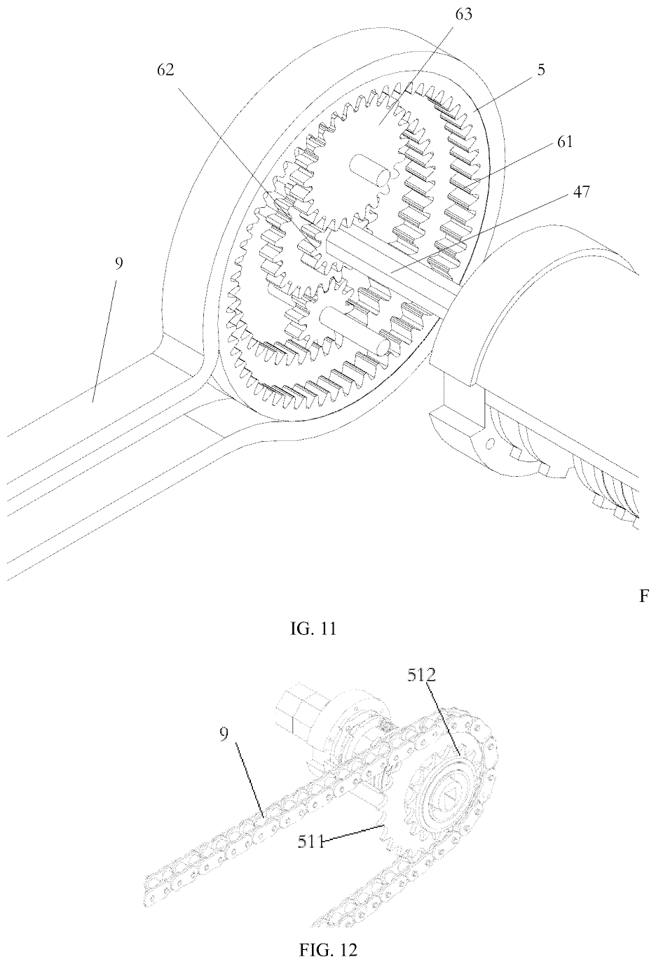

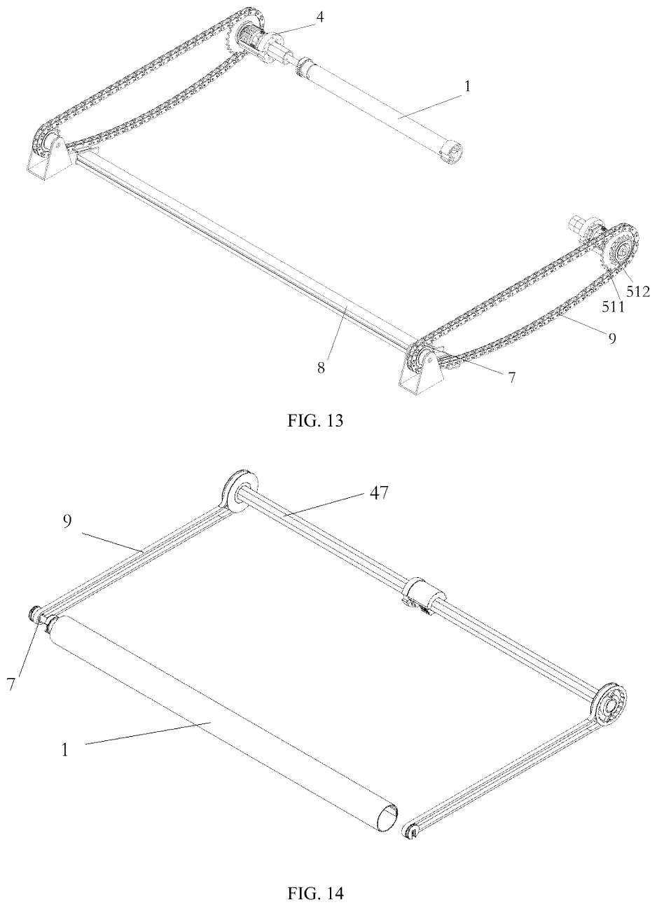

As shown in FIGS. 12 and 13, in this example, the driving medium 9 is a transmission chain; the outer peripheral contours of the driving wheel and positioning roller 7 have teeth that match the transmission chain, ensuring that there is no slippage between the transmission chain and the driving wheel, as well as between the transmission chain and the positioning roller 7. The driving wheel assembly does not include a pawl or a pawl support shaft, but the number of driving wheels is m, specifically the first-gear driving wheel . . . the mth-gear driving wheel, where m>1. The radius of the first-gear driving wheel is the largest, the radius of the second-gear driving wheel is the next largest, . . . , and the radii decrease sequentially, with the radius of the mth-gear driving wheel being the smallest. In this example, m equals 2, that is, the driving wheels include the first-gear driving wheel 511 and the second-gear driving wheel 512. The hollow shaft 47 is drive-connected to the driving wheels via a mountain bike shifting mechanism, ensuring the driving medium 9 to shift between driving wheels of different radii.

During winding, the shifting mechanism (i.e., the mountain bike shifting mechanism) switches to the smaller-radius driving wheel (the second-gear driving wheel 512), thereby achieving the purpose of having the curtain material radius greater than the driving wheel radius, ensuring that the curtain material remains tensioned during winding even when the roller blind with a tensioning device winds; During unwinding, the shifting mechanism switches to the larger-radius driving wheel (first-gear driving wheel 511), thereby achieving a curtain material radius smaller than the driving medium radius, ensuring that the curtain material remains tensioned when the roller blind with a tensioning device unwinds. The remaining is the same as in Example 1. For example, the two ends of the bottom rail 8 are connected to the driving medium 9, ensuring the bottom rail 8 to move with the driving medium 9. The installation positions of the power source 1 and the synchronizing device assembly 4 are the same as in Example 1.

### Example 12

In this example, the driving medium is a transmission chain, and the ratchet gear is a ratchet chain sprocket that can be driven in conjunction with the transmission chain. The outer contour of the ratchet chain sprocket is provided with bulging teeth that can engage in the gaps between the transmission chains, thereby ensuring synchronous transmission between the transmission chain and the ratchet chain sprocket without slippage. The remaining is the same as in Example 1.

### Example 13

In this example, the driving medium is a transmission belt, and the driving gear is a ratchet belt wheel that can be driven in conjunction with the transmission belt. The remaining is the same as in Example 1 or 10.

### Example 14

In this example, the driving medium is a transmission wire, and the ratchet gear is a ratchet wire wheel that can be driven in conjunction with the transmission wire. The remaining is the same as in Example 1 or 10.

### Example 15

In this example (FIGS. 14 and 15), the power source 1 is positioned on the axis where the positioning roller 7 is located. By rotating the positioning roller 7, the driving medium 9 is driven; the driving medium 9 then drives the driving wheel assembly to rotate; the driving wheel assembly drives the friction assembly to rotate via the hollow shaft 47; the friction assembly drives the housing to rotate; the housing drives the roller 2 to rotate, thereby achieving the unwinding and/or winding of the curtain material 3. The inner ring contour of the second friction ring is provided with a second interlocking component that matches the outer contour of the hollow shaft 47, ensuring the second friction ring to rotate with the shaft; the outer ring contour of the first friction ring is provided with a first interlocking component matching the inner wall of the housing, ensuring the housing to rotate with the first friction ring. The remaining is the same as in Example 1.

### Example 16

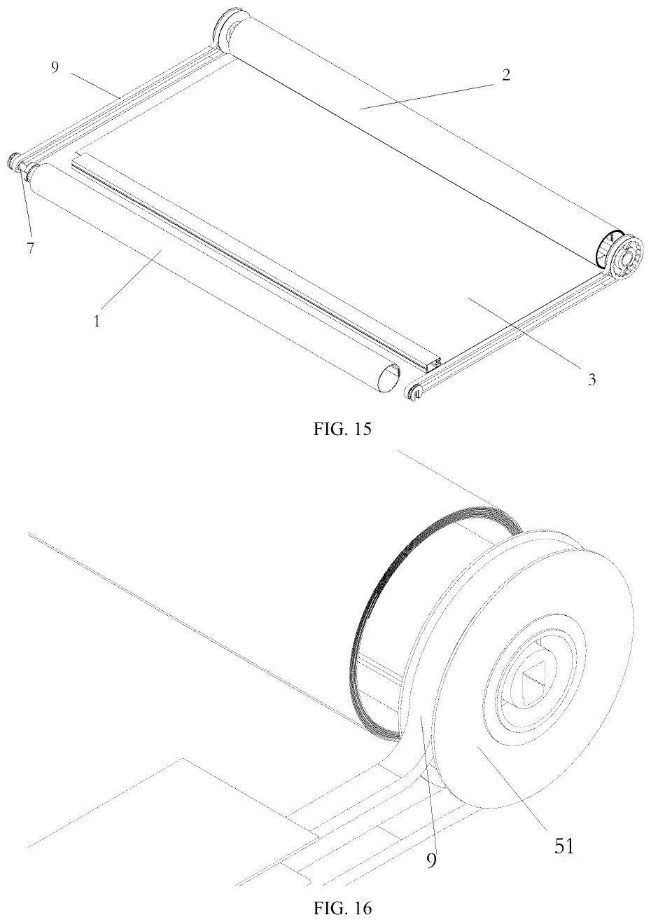

In this example (FIG. 16), no synchronizing device assembly exists, and the synchronizing effect is achieved by sliding friction between the driving wheel 51 and the driving medium 9. No pawl or pawl support shaft exists in the one-way wheel assembly. The remaining is the same as in Example 1.

### Example 17

In this example, the housing is drive-connected to the power source; the shaft and the power source are arranged on the same axis. The two ends of the roller are provided with auxiliary wheels; the driving medium surrounds the auxiliary wheel. The power source transmits to the friction assemblies via the housing, which in turn drive the driving wheel assembly via the shaft; thereby ensuring the auxiliary wheel to rotate via the driving medium, driving the roller to rotate and achieving the unwinding and/or winding of the curtain material. The remaining structure is the same as in Example 1 or 10.

### Example 18

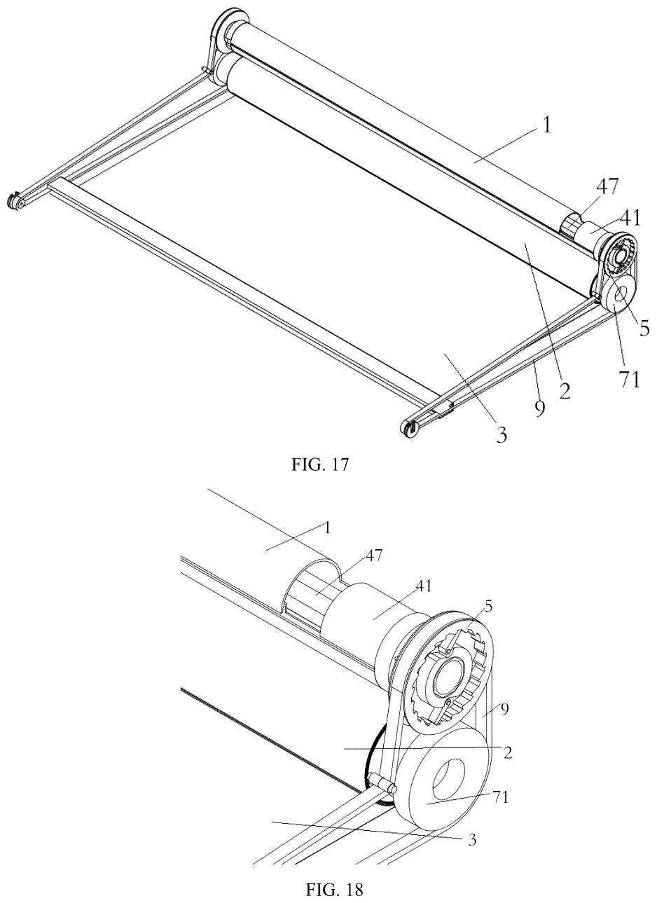

In this example (FIGS. 17 and 18), the hollow shaft 47 is drive-connected to the power source 1; the hollow shaft 47 is arranged on the same axis as the power source 1. The two ends of the roller are provided with auxiliary wheels 71; the driving medium 9 surrounds the auxiliary wheel 71. The power source 1 transmits to the friction assembly through the hollow shaft 47, and then to the housing 41, drives the driving wheel assembly 5, so that the auxiliary wheel 71 is driven to rotate through the driving medium 9, and the roller 2 is driven to rotate to realize the unwinding and/or winding of the curtain material 3. The remaining structure is the same as in Example 1.

### Example 19

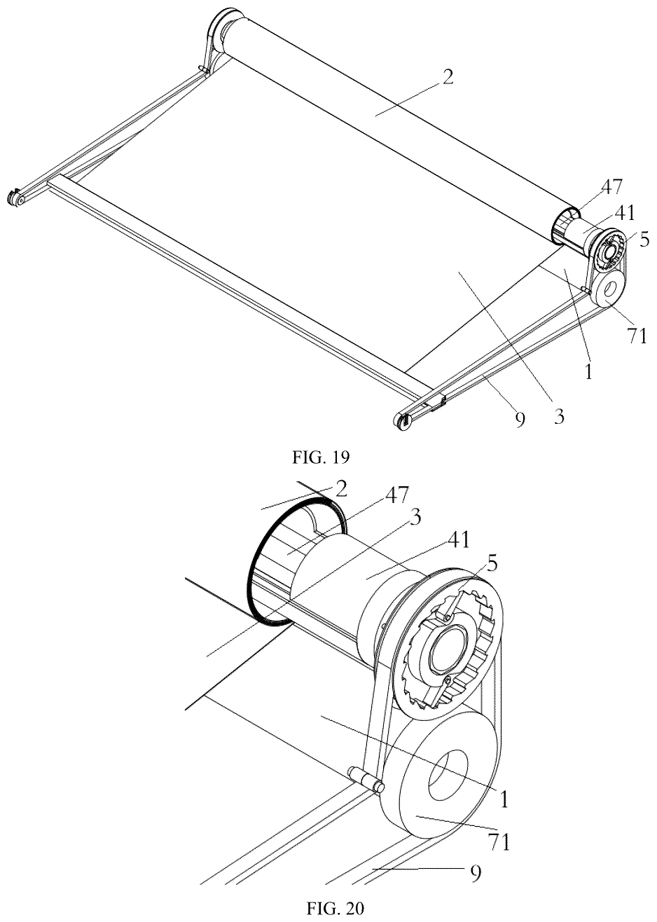

In this example (FIG. 19 and FIG. 20), the shaft (not only the hollow shaft 47, but also a solid shaft) is drive-connected to the roller 2; the shaft and the roller 2 are arranged on the same axis. The power source 1 is provided with auxiliary wheels 71 at both ends; driving medium 9 is also mounted around the auxiliary wheels 71; power source 1 drives driving medium 9 via the auxiliary wheels 71, and drives the driving wheel assembly 5. The driving wheel assembly 5 then drives the friction assembly via the housing 41 to rotate the shaft, thereby driving the roller 2 to rotate and achieve the unwinding and/or winding of the curtain material 3. The remaining structure is the same as in Example 1 or 10. In this invention, unless the realization of the technical effect requires the shaft to be a hollow shaft, no specific requirements are imposed on whether the shaft is hollow. For example, in an embodiment where the wires of power source pass through the shaft, the shaft must be hollow. In case of no such technical effect to achieve, there is no need to specifically require the shaft to be hollow.

### Example 20

In this example, the housing is drive-connected to the roller; the shaft and the roller are arranged on the same axis. The power source has auxiliary wheels at both ends; the driving medium also surrounds the auxiliary wheels; the power source drives the driving mediums via the auxiliary wheels, the driving mediums then drive the driving wheel assembly, the driving wheel assembly then drives the friction assembly via the shaft to rotate the housing, thereby ensuring the roller to rotate and achieve the unwinding and/or winding of the curtain material. The remaining structure is the same as in Example 1 or 10.

The above description details the specific preferred embodiments of the present invention but does not exhaust all possible embodiments. It should be understood that those skilled in the art can make numerous modifications and changes based on the concepts of the present invention without requiring creative labor. Therefore, any technical solutions that can be obtained by skilled persons in this technical field based on the existing technology through logical analysis, reasoning, or limited experiments in accordance with the concept of the present invention should be within the scope of protection determined by the claims.

What is claimed is:

1. A roller blind with a tensioning device, wherein the roller blind comprises a power source, a roller, a curtain material, a length-limiting locating element, and a tensioning device; the length-limiting locating element is configured to limit an unwinding length of the curtain material and comprises a positioning roller; the tensioning device comprises a driving medium and a driving wheel assembly; the driving wheel assembly comprises a driving wheel, a pawl and a pawl support shaft; the driving medium is ring-shaped and wraps around the driving wheel and the positioning roller;
the power source is drive-connected to the roller, and the roller is connected to the driving medium via the driving wheel assembly, ensuring the driving medium to rotate with the roller; the roller is further connected to the driving medium via the curtain material;
the tensioning device further comprises a synchronizing device assembly; the synchronizing device assembly comprises a housing, a friction assembly, and a shaft; the synchronizing device assembly is drive-connected to the roller;
the friction assembly comprises a first friction ring and a second friction ring; the shaft passes through the first friction ring and the second friction ring; an inner ring contour of the second friction ring is provided with a second interlocking component that matches an outer contour of the shaft, ensuring the second friction ring to rotate synchronously with the shaft; the first friction ring is in close contact with the second friction ring, and a friction force between the first friction ring and the second friction ring drives the first friction ring and the second friction ring to rotate in the same direction; an outer ring contour of the first friction ring is provided with a first interlocking component matching the inner wall of the housing, ensuring the housing to rotate synchronously with the first friction ring; the synchronizing device assembly is drive-connected to the driving medium via the driving wheel assembly;
the driving wheel is a ratchet gear; ratchets of the ratchet gear are inclined towards the same rotation direction and arranged around an inner circumferential surface of the ratchet gear; a front end of the pawl is positioned within the ratchets of the ratchet gear, and a root of the pawl is arranged on an outer circumferential surface of the pawl support shaft; the driving wheel assembly is configured such that: when a rotational direction of the pawl support shaft is the same as an inclination direction of the ratchets of the ratchet gear, the pawl engages within the ratchets of the ratchet gear, driving the ratchet gear and the pawl support shaft to rotate synchronously in the same direction; when the rotational direction of the pawl support shaft is opposite to the inclination direction of the ratchets of the ratchet gear, the pawl slips within the ratchets of the ratchet gear, and the ratchet gear does not rotate synchronously with the pawl support shaft; the driving wheel assembly only slips when rotating in a winding direction, and when rotating in an unwinding direction, the pawl and the ratchets of the ratchet gear are in a meshing state to push the ratchet gear to rotate; the pawl support shaft is drive-connected to the roller.

2. The roller blind with the tensioning device according to claim 1, wherein the housing of the synchronizing device assembly is drive-connected to the roller; the shaft of the synchronizing device assembly is drive-connected to the driving medium via the driving wheel assembly.

3. The roller blind with the tensioning device according to claim 2, wherein the housing is integrally formed with the roller.

4. The roller blind with the tensioning device according to claim 1, wherein the shaft of the synchronizing device assembly is drive-connected to the roller; the housing of the synchronizing device assembly is drive-connected to the driving medium via the driving wheel assembly.

5. The roller blind with the tensioning device according to claim 1, wherein the synchronizing device assembly further comprises an adjusting assembly; the adjusting assembly regulates the friction force between the first friction ring and the second friction ring by applying pressure to the friction assembly.

6. The roller blind with the tensioning device according to claim 5, wherein the adjusting assembly comprises an elastic element; the elastic element controls the pressure applied to the friction assembly through a deformation extent, wherein the friction force between the first friction ring and the second friction ring is regulated.

7. The roller blind with the tensioning device according to claim 6, wherein the adjusting assembly further comprises a first pressure-applying member; the elastic element transmits the pressure generated by elastic deformation through the first pressure-applying member to the friction assembly.

8. The roller blind with the tensioning device according to claim 7, wherein an outer contour of the first pressure-applying member is identical to an outer contour of the first friction ring, ensuring the first pressure-applying member to rotate with the housing.

9. The roller blind with the tensioning device according to claim 7, wherein the first pressure-applying member is ring-shaped; an inner ring contour of the first pressure-applying member is identical to the inner ring contour of the second friction ring, wherein the shaft is configured to rotate with the first pressure-applying member.

10. The roller blind with the tensioning device according to claim 7, wherein the adjusting assembly further comprises a second pressure-applying member; the first pressure-applying member, the elastic element, and the second pressure-applying member are arranged in sequence.

11. The roller blind with the tensioning device according to claim 10, wherein the first pressure-applying member and the second pressure-applying member are ring-shaped;
an outer contour of the first pressure-applying member and an outer contour of the second pressure-applying member are both identical to an outer contour of the first friction ring, ensuring the first pressure-applying member and the second pressure-applying member to rotate with the housing; or
an inner contour of the first pressure-applying member and an inner contour of the second pressure-applying member are both identical to an inner contour of the second friction ring, ensuring the shaft to rotate with the first pressure-applying member and the second pressure-applying member.

12. The roller blind with the tensioning device according to claim 6, wherein the deformation extent of the elastic element is adjusted by a fastener; the fastener comprises an ejector pin; extension and retraction of the ejector pin cause the elastic deformation force acting on the elastic element to change, wherein the deformation extent of the elastic element is adjusted.

13. The roller blind with the tensioning device according to claim 12, wherein the adjusting assembly further comprises a first pressure-applying member and a second pressure-applying member; the first pressure-applying member, the elastic element, and the second pressure-applying member are arranged in sequence; and the fastener is arranged on the first pressure-applying member and/or the second pressure-applying member.

14. The roller blind with the tensioning device according to claim 12, wherein the adjusting assembly and the friction assembly are arranged in a space enclosed by a side wall and an end plate of the housing; the ejector pin passes through the end plate of the housing; a first end of the ejector pin abuts the adjusting assembly, and a second end of the ejector pin is exposed on an outer side of the end plate and is provided with a fixture to control a length of the ejector pin extending into an inner side of the end plate.

15. The roller blind with the tensioning device according to claim 1, wherein the first interlocking component is an outwardly extending protrusion, and the inner wall of the housing is provided with a corresponding depression matching the first interlocking component; or the first interlocking component is an inwardly recessed depression, and the inner wall of the housing is provided with a corresponding protrusion matching the first interlocking component; or the first interlocking component comprises both an outwardly extending protrusion and an inwardly recessed depression, the inner wall of the housing is provided with a depression matching the outwardly extending protrusion at a corresponding position of the outwardly extending protrusion and the inner wall of the housing is provided with a protrusion matching the inwardly recessed depression at a corresponding position of the inwardly recessed depression.

16. The roller blind with the tensioning device according to claim 1, wherein a cross-sectional inner wall contour of the housing is not circular, and an outer contour of the first friction ring matches the cross-sectional inner wall contour of the housing, ensuring the first friction ring to rotate with the housing; the first interlocking component is a portion of the outer contour of the first friction ring that matches the inner wall contour of the cross-section of the housing.

17. The roller blind with the tensioning device according to claim 1, wherein the second interlocking component is an inwardly extending protrusion, the outer contour of the shaft is provided with a depression corresponding to the second interlocking component; or the second interlocking component is a depression that extends inward into the ring, and the outer contour of the shaft is provided with a protrusion corresponding to the second interlocking component; or the second interlocking component comprises both an inwardly extending protrusion and a depression that extends inward into the ring, the outer contour of the shaft is provided with a depression corresponding to the inwardly extending protrusion at a corresponding position of the inwardly extending protrusion, and the outer contour of the shaft is provided with a protrusion corresponding to the inwardly recessed depression at a corresponding position of the inwardly recessed depression.

18. The roller blind with the tensioning device according to claim 1, wherein a cross-sectional outer contour of the shaft is not circular, and an inner contour of the second friction ring matches the cross-sectional outer contour of the shaft, ensuring the shaft to rotate with the second friction ring; the second interlocking component is a portion of the inner contour of the second friction ring that matches the outer contour of the cross-section of the shaft, wherein the inner ring contour of the second friction ring matches the outer contour of the cross-section of the shaft.

19. The roller blind with the tensioning device according to claim 1, wherein a number of the first friction rings or second friction rings is greater than 1, and a transmission effect of the housing to the shaft is adjusted by changing a friction area through adjusting an arrangement of the first friction rings and second friction rings.

20. The roller blind with the tensioning device according to claim 1, wherein the power source is set within the roller; a power source's wires pass through the shaft to connect to a power outlet.

21. The roller blind with the tensioning device according to claim 1, wherein the power source has auxiliary wheels at both ends; the driving medium further surrounds the auxiliary wheels; the power source drives the driving mediums via the auxiliary wheels, the driving mediums in turn drive the driving wheel assembly; the driving wheel assembly drives the roller via the synchronizing device assembly, wherein the roller is ensured to rotate and achieve unwinding and/or winding of the curtain material.

22. The roller blind with the tensioning device according to claim 1, wherein the power source is positioned on an axis where the positioning roller is located, driving the positioning roller to rotate, wherein the driving medium is driven to rotate, the driving medium drives the driving wheel assembly, the driving wheel assembly is rotated via the synchronizing device assembly, wherein the roller is driven to rotate and achieve unwinding and/or winding of the curtain material.

23. The roller blind with the tensioning device according to claim 1, wherein a radius of the curtain material wound on the roller is no greater than a radius of the driving medium on the driving wheel.

24. (canceled)

25. (canceled)

26. (canceled)

27. (canceled)

28. (canceled)

29. (canceled)

30. (canceled)

31. (canceled)
